(19) United States
(12) Patent Application Publication
(10) Pub. No.: US 2013/0159689 A1
(43) Pub. Date: Jun. 20, 2013

(54) METHOD AND APPARATUS FOR INITIALIZING EMBEDDED DEVICE

(71) Applicants: Ho-Joon Park, Daejeon (KR); Chae-Deok Lim, Daejeon (KR); Dong-Wook Kang, Daejeon (KR); Han-Sung Chun, Daejeon (KR)

(72) Inventors: Ho-Joon Park, Daejeon (KR); Chae-Deok Lim, Daejeon (KR); Dong-Wook Kang, Daejeon (KR); Han-Sung Chun, Daejeon (KR)

(73) Assignee: ELECTRONICS AND TELECOMMUNICATIONS RESEARCH INSTITUTE, Daejeon (KR)

(21) Appl. No.: 13/545,308

(22) Filed: Jul. 10, 2012

(30) Foreign Application Priority Data
Dec. 15, 2011 (KR) 10-2011-0135925

(51) Int. Cl. G06F 9/24

(52) U.S. Cl. 713/2

(57) ABSTRACT

The present invention relates generally to a method and apparatus for initializing an embedded device. When a boot loader is executed and a kernel is loaded, an initialization program is executed, and a booting sequence including information about an operating sequence of a boot process is loaded. Thereafter, initialization functions which are included in a script replacement function module of the embedded device are executed, and then a state of the embedded device is set to a usable state. Accordingly, the method and apparatus can efficiently perform the operations of an initialization program that is used to solve the complexity of the initialization of an OS inevitably appearing on mobile devices and high-performance embedded devices, and an initialization script that is operated to flexibly execute the initialization program on various devices having different characteristics.

### CROSS REFERENCE TO RELATED APPLICATION

This application claims the benefit of Korean Patent Application No. 10-2011-0135925, filed on Dec. 15, 2011, which is hereby incorporated by reference in its entirety into this application.

### BACKGROUND OF THE INVENTION

1. Technical Field

The present invention relates generally to a method and apparatus that are applied to an Operating System (OS) installed on an embedded device and, more particularly, to a method and apparatus for initializing an embedded device, which can efficiently perform the operations of an initialization program that is used to solve the complexity of the initialization of an OS inevitably appearing on mobile devices and high-performance embedded devices, and an initialization script that is operated to flexibly execute the initialization program on various devices having different characteristics.

2. Description of the Related Art

Embedded devices may be defined as computer systems having restricted uses and a limited range of use, unlike general-purpose computers. However, such an embedded device also corresponds to a single computer, so that the execution of an Operating System (OS) to utilize the computer is an essential element.

Further, an OS installed on an embedded device is required to have a performance and applicability as high as that of an OS installed on a Personal Computer (PC) so as to support an embedded device such as a smartphone whose performance is as high as that of a PC. Furthermore, embedded devices on which an OS identical to that of a PC is installed have also made their appearance.

Furthermore, in order for the OS of an embedded device or a PC to operate, performing an initialization process is essential. As a device becomes closer to a high-performance device, the process and system thereof become more and more complicated.

This initialization process is referred to as a boot process. In typical embedded devices, an initialization program and an initialization script are used to improve the flexibility of the devices. That is, the developer of embedded devices can apply the same OS to different products by modifying an initialization script with a small amount of effort, or can change the use of a product by applying different initialization scripts to the same product as needed. This is possible because scripts are not binary programs that have been formed to be cross-compiled on a separate host computer like application programs, but a developer and a user can directly read and modify initialization scripts installed on embedded devices in text format.

However, behind such flexibility, there are factors detracting from booting performance. Generally, during the procedure of booting an embedded device, the booting time is the time it takes for a user to prepare the product for use when turning on the product after the product was released, and interferes with the use of the product. Therefore, the added value of products can be improved only when the products have been released so that the booting time thereof is minimized in order to improve the value of products.

That is, an initialization program and an initialization script may be a strong tool capable of providing flexibility and easily incorporating descriptions and settings from the standpoint of a developer, but a user who has purchased a product does not require such flexibility, and thus the initialization program and script become factors that interfere with the improvement of the value of products.

Further, the reason the initialization program and script detract from booting performance is that they occupy a considerable portion of the overall booting time. A list of the detailed reasons is as follows:

First, processing is executed based on an interpreter. Since the code of a script must be directly read by the developer, an interpreter is required to execute the code. Since pieces of text-based code are executed by analyzing sentences having a considerably complicated format, they become a factor interfering with the improvement of booting performance.

Second, separate program code for processing scripts is required. In the case of an embedded device, hardware configuration is closely related with the unit price of products, unlike a PC. In order to process scripts, a memory device and files for the scripts are required, so that there are problems in that time is required to execute the memory device and the files and, in addition, the products are depreciated because the unit price of the products cannot be reduced.

Third, the initialization program and script excessively use a file system. At least one initialization script used by the initialization program is included in the file system. The file system operates several tens to several hundreds of times or more slower than does a memory device, so that the initialization program must access the file system several times so as to run the initialization script, and typical embedded devices construct a boot process using about a dozen or more scripts.

Fourth, there is the problem of the duplication of a process control block. A process is a task unit in which a kernel executes a task. In order to control this process, the kernel configures and manages a process control block for each process. To generate a new program in an OS using a procedure performed in the kernel, the process control block used in the kernel must be duplicated. As a script becomes more complicated, this phenomenon frequently occurs during a boot process. In a typical embedded OS, duplication occurs about 700 times until booting has been completed.

Fifth, there is the problem of symbolic link tracking. This becomes a problem in some embedded OSs. In order to improve the efficiency of an initialization program, a scheme for storing several functions used by the initialization script in a single program, representing the functions by links corresponding to the respective functions, and executing the functions has been used. However, these links are also present in the file system, and the initialization program must access the file system several times to read the links, similarly to what occurs in the second problem.

Sixth, there is the problem of the occupation of a memory device. This problem occurs when several functions used by the initialization script are stored in a single program, similarly to what occurs in the fifth problem. That is, there is no problem when only functions used in a single OS are utilized, but unnecessary functions are also included upon inserting several functions into a single place. Of course, this problem occurs when one intends to utilize the advantage of being able to use a single program in a plurality of embedded devices. Accordingly, a large-scale program must be installed in a memory device, so that a larger memory device must be mounted to load the large-scale program, thus increasing the unit price of the products and detracting from the value of the products.

Finally, there is a security problem. A function-integrated program corresponding to the fifth and sixth items provides high usability to developers, but after products have been released, it is also possible for users to use this function. Therefore, this may detract from the value of products and, in addition, cause a problem in security, creating a large social issue.

That is, there are a plurality of problems that may be caused by the initialization program and the initialization script on embedded devices, as described above.

### SUMMARY OF THE INVENTION

Accordingly, the present invention has been made keeping in mind the above problems occurring in the prior art, and an object of the present invention is to provide an apparatus and method for initializing an embedded device, which configure the initialization program and the initialization script of an embedded device into a single program, thus saving memory space, solving the problem of duplication, and improving booting performance.

In accordance with an aspect of the present invention to accomplish the above object, there is provided a method of initializing an embedded device, including when a boot loader is executed and a kernel is loaded, executing an initialization program, loading a booting sequence including information about an operating sequence of a boot process, executing any one of a file system initialization function, a kernel module initialization function, a network configuration function, an application program startup function, and an environment variable setup function, which are included in a script replacement function module of the embedded device, based on the loaded booting sequence, and setting a state of the embedded device to a usable state.

In accordance with another aspect of the present invention to accomplish the above object, there is provided an apparatus for initializing an embedded device, including a startup module including at least one of a file system initialization function execution module, a kernel module initialization function execution module, a network configuration function execution module, an application program startup function execution module, and an environment variable setup function execution module, as an initialization script replacement function module, a booting sequence control module for loading a booting sequence including information about an operating sequence of a boot process, and performing control such that the startup module performs an initialization script replacement function based on the loaded booting sequence, and an initialization program module for, when a boot loader is executed and a kernel is loaded, executing a function of the startup module via the booting sequence control module, and setting a state of the embedded device to a usable state.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a process for initializing an embedded device;

FIG. 2 is a flowchart showing a method of initializing an embedded device according to an embodiment of the present invention;

FIG. 3 is a diagram showing in detail the step of performing the initialization script replacement function of FIG. 2; and

FIG. 4 is a diagram showing the configuration of an apparatus for initializing an embedded device according to an embodiment of the present invention.

### DESCRIPTION OF THE PREFERRED EMBODIMENTS

Hereinafter, various embodiments of the present invention will be described in detail with reference to the attached drawings. Further, the terms “unit,” “module,” and “device” related to components used in the following description are merely assigned for the sake of the simplicity of description of the present specification and may be used together and designed using hardware or software.

Furthermore, embodiments of the present invention will be described in detail with reference to the attached drawings and contents described in the drawings, but the present invention is not limited or restricted by the above embodiments.

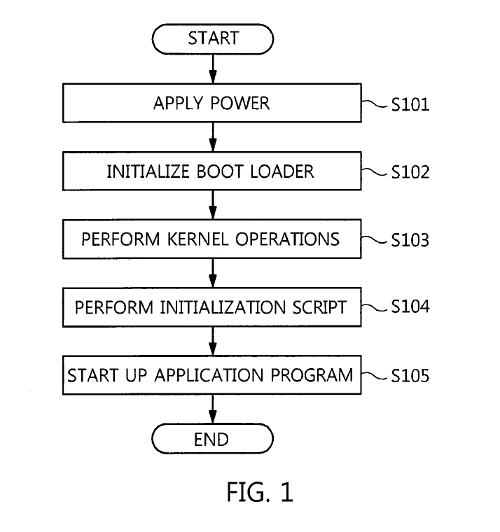

FIG. 1 is a flowchart showing a process for initializing an embedded device.

The process for initializing the embedded device is called a boot process. As shown in FIG. 1, in the case of a typical embedded device, when power is applied to the embedded device at step S101, the boot process may be performed in the sequence of a boot loader step S102, a kernel step S103, an initialization (initial) script step S104, and an application program initialization (startup) step S105.

The individual functions are described in detail below. The boot loader step S102 is a program executed first after the application of the power to the embedded device, is implemented as simple code, and may function to read a kernel, which will be subsequently initialized, into a memory device. Further, the kernel step S103 is the core part of an Operating System (OS), resides in the memory device, and continuously performs the function of the OS until the system is sustained. The kernel can mainly perform operations required for scheduling, memory device management, file management, etc.

Most embedded devices perform the boot loader step, which is the previous step, and the procedure of initializing the kernel, in the same manner, but perform the initialization script step S104 in different manners depending on the use of the embedded devices and depending on whether the embedded devices are to be used. At the initialization script step S104, operations required to mount a file system, upload a kernel module, set up environment variables, and load subsequent application programs may be performed. The operations required to load application programs may include the operation of reading application programs from files into the memory device so that the execution of the application programs is possible.

Next, the application program startup step S105 is a program that can be used by the user as the actual use of a relevant embedded device. After this process has terminated, the boot process is completed and the embedded device can be normally used.

In the present invention, a subject which performs the initialization script step and the application program startup step is defined as an initialization program module. A method, by which the initialization program conducts file system mounting, kernel module uploading, environment variable setup, and application program loading which are required to start up the application program, is defined as the initialization script.

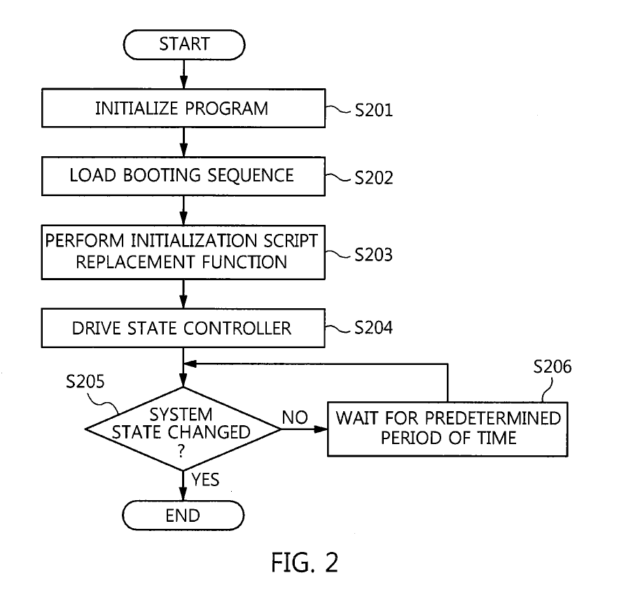

FIG. 2 is a flowchart showing a method of initializing an embedded device according to an embodiment of the present invention.

First, program initialization is executed at step S201.

In accordance with an embodiment, the initialization program module starts an operation by taking over the right of control from the kernel, and subsequently performs program initialization. Further, program initialization is conducted using a process startup module and may be configured to perform the initialization of console output and the initialization of other programs.

Next, a booting sequence is loaded at step S202.

That is, the initialization program loads a boot process configured in the form of arrays using a boot process control function.

Next, an initialization script replacement function is performed at step S203.

According to the embodiment, based on the loaded booting sequence, any one of functions included in the script replacement function module of the embedded device, that is, a file system initialization function, a kernel module initialization function, a network configuration function, an application program startup function, and the environment variable initialization (setup) function, is performed, thus enabling the state of the embedded device to be set to a usable state.

Next, the initialization program drives a state controller at step S204, and the state controller determines whether a system state has changed at step S205. If it is determined that the system state has not changed, the state controller waits for a predetermined period of time at step S206, determines the state again, and terminates the initialization program if the system state has changed. The initialization program must be executed at a level higher than those of all application programs, so that when the initialization program is terminated, the system cannot be used any longer.

That is, as shown in FIG. 2, the initialization program and the initialization script are integrated into a single program, and replace an existing initialization program. Accordingly, the initialization script does not exist separately, so that the number of accesses to the file system can be minimized.

Further, since the initialization script is not revealed to the user, security can be strengthened, a small amount of the space of the memory device is occupied, and the unit price of products can be reduced.

Furthermore, since the kernel does not need to form a separate process for the initialization script, initialization can be rapidly performed, which can result in the improvement of booting performance. In addition, since most contents in the file system are required to perform the boot process except for application programs, those contents are omitted, so that the complexity of the process is decreased, and personnel expenses required to manufacture products and opportunity costs such as technical costs are reduced, thus improving the value of products.

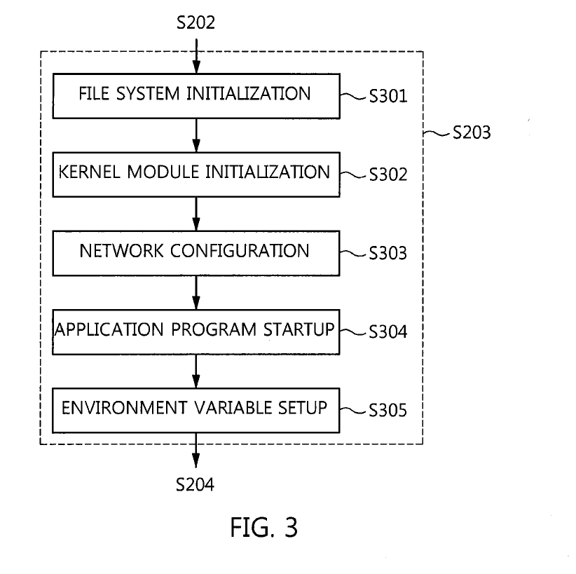

FIG. 3 is a diagram showing in detail the step of performing the initialization script replacement function of FIG. 2.

In accordance with the embodiment, when performing the initialization script replacement function, a file system initialization function S301, a kernel module initialization function S302, a network configuration function S303, an application program startup function S304, and an environment variable setup function S305, which are included in the script replacement function module of the embedded device, may be performed based on booting sequence information.

Further, the sequence of the execution of the functions shown in FIG. 3 is only an example and may be changed depending on the uses and functions of embedded devices.

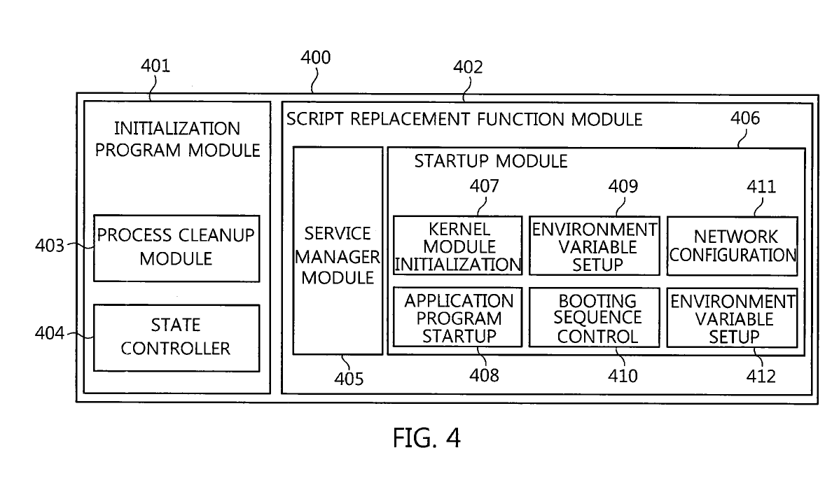

FIG. 4 is a diagram showing the configuration of an apparatus for initializing an embedded device according to an embodiment of the present invention.

In accordance with the embodiment, an initialization apparatus 400 may include an initialization program module 401 and an initialization script replacement function module 402.

The initialization program module 401 may include, as internal functions, a process initialization and termination support module (process cleanup module) 403 and a system state controller (state controller) 404. The system state controller can control states classified into a normal state, a power-off state, and a reboot state, as internal states.

Further, the initialization program module drives a startup module 406 using the initialization script replacement function module immediately after taking over the right of control from the kernel, thus performing the boot process.

The initialization script replacement function module may include a service manager module 405 and the startup module 406, and the service manager module 405 may conduct the boot process by subdividing it into a standalone type, a super daemon type, and a respawn type according to the functionality.

Further, the startup module 406 may include, as detailed components, a kernel module initialization function 407, a file system initialization function 409, a network configuration function 411, an application program initialization (application startup) function 408, an environment variable setup function 412, and a booting sequence control function 410.

The booting sequence control function 410 is a function corresponding to the main body of the existing initialization script, and the initialization program may conduct a boot process using the remaining five functions 407, 408, 409, 411, and 412 via the corresponding module.

Further, if all of the boot process has been completed, the initialization program can drive the state controller 404, and the state controller 404 can determine whether a system state has changed, waits for a predetermined period of time if a system state has not changed, and then determines the system state again. In contrast, if the system state has changed, the state controller terminates the initialization program. The initialization program must be executed at a level higher than those of all application programs, so that when the initialization program has terminated, the system cannot be used any longer.

As described above, when the method and apparatus for initializing an embedded device according to the present invention are used, a process for initializing an OS installed on the embedded device can be rapidly performed, the value of products can be improved, and the costs of manufacturing products can be reduced. Further, since an initialization script is not used, security can be improved.

Further, since the execution of a boot process can be simplified in a development procedure compared to an existing scheme, the personnel costs and the opportunity costs can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. These modifications should not be understood separately from the technical spirit or prospect of the present invention.

What is claimed is:

1. A method of initializing an embedded device, comprising:
executing an initialization program when a boot loader is executed and a kernel is loaded;
loading a booting sequence including information about an operating sequence of a boot process;
executing any one of a file system initialization function, a kernel module initialization function, a network configuration function, an application program startup function, and an environment variable setup function, which are included in a script replacement function module of the embedded device, based on the loaded booting sequence; and
setting a state of the embedded device to a usable state.

2. The method of claim 1, wherein the setting the embedded device to the usable state is configured such that the embedded device is set to the usable state without performing an operation of accessing a file system of the initialization program.

3. The method of claim 1, further comprising:
driving a state controller; and
detecting a change in a system state of the embedded device via the driven state controller, and terminating the initialization program if the change in the system state has been detected.

4. The method of claim 3, wherein the state controller detects a change in a system state corresponding to any one of a normal state, a power-off state, and a reboot state.

5. The method of claim 3, wherein the terminating the initialization program comprises, waiting for a predetermined period of time, and then detecting again a change in the system state of the embedded device, if a change in the system state has not been detected.

6. An apparatus for initializing an embedded device, comprising:
a startup module including at least one of a file system initialization function execution module, a kernel module initialization function execution module, a network configuration function execution module, an application program startup function execution module, and an environment variable setup function execution module, as an initialization script replacement function module;
a booting sequence control module for loading a booting sequence including information about an operating sequence of a boot process, and controlling that the startup module performs an initialization script replacement function based on the loaded booting sequence; and
an initialization program module for, when a boot loader is executed and a kernel is loaded, executing a function of the startup module via the booting sequence control module, and setting a state of the embedded device to a usable state.

7. The apparatus of claim 6, wherein the initialization program module sets the state of the embedded device to the usable state without accessing a file system after the initialization program has been executed.

8. The apparatus of claim 6, further comprising a state controller for detecting a change in a system state of the embedded device, and terminating the initialization program if a change in the system state has been detected.

9. The apparatus of claim 8, wherein the state controller detects a change in a system state corresponding to any one of a normal state, a power-off state, and a reboot state.

10. The apparatus of claim 8, wherein the state controller waits for a predetermined period of time and then detects again a change in the system state of the embedded device if a change in the system state has not been detected.
